(19) United States
(12) Patent Application Publication
(10) Pub. No.: US 2021/0264306 A1
(43) Pub. Date: Aug. 26, 2021

(54) UTILIZING MACHINE LEARNING TO DETECT SINGLE AND CLUSTER-TYPE ANOMALIES IN A DATA SET

(71) Applicant: Accenture Global Solutions Limited, Dublin (IE)

(72) Inventors: Maziyar BARAN POUYAN, Emeryville, CA (US); Saeideh SHAHROKH ESFAHANI, Mountain View, CA (US); Vivek Kumar KHETAN, San Francisco, CA (US); Andrew E. FANO, Lincolnshire, IL (US)

(21) Appl. No.: 17/248,848

(22) Filed: Feb. 10, 2021

Related U.S. Application Data
(60) Provisional application No. 62/979,599, filed on Feb. 21, 2020.

(51) Int. Cl. G06N 7/00; G06N 20/00

(52) U.S. Cl. CPC G06N 7/005; G06N 20/00

(57) ABSTRACT

A device may receive unlabeled data associated with a particular domain and may select sets of data from the unlabeled data. The device may calculate Gaussian kernel densities and minimum distances for data points in each of the sets of data and may calculate anomaly scores for the data points based on the Gaussian kernel densities and the minimum distances for the data points. The device may train a machine learning model, with the anomaly scores for the data points, to generate a trained machine learning model that determines a single anomaly score for the data points, wherein a plurality of single anomaly scores is determined for the sets of data. The device may calculate a final anomaly score for the unlabeled data based on a combination of the plurality of single anomaly scores and may perform one or more actions based on the final anomaly score.

### CROSS REFERENCE TO RELATED APPLICATION

This patent application claims priority to U.S. Provisional Patent Application No. 62/979,599, filed on Feb. 21, 2020, and entitled “UTILIZING MACHINE LEARNING TO DETECT SINGLE AND CLUSTER-TYPE ANOMALIES IN A DATA SET.” The disclosure of the prior application is considered part of and is incorporated by reference into this patent application.

### BACKGROUND

Anomalies are data points of a data set that include different data properties than normal data points of the data set. In data analysis, anomaly detection is the identification of rare items, events, or observations which raise suspicions by differing significantly from a majority of data.

### SUMMARY

In some implementations, a method may include receiving unlabeled data associated with a particular domain and selecting sets of data from the unlabeled data. The method may include calculating Gaussian kernel densities and minimum distances for data points in each of the sets of data, and calculating anomaly scores for the data points in each of the sets of data based on the Gaussian kernel densities and the minimum distances for the data points in each of the sets of data. The method may include training a machine learning model, with the anomaly scores for the data points in each of the sets of data, to generate a trained machine learning model that determines a single anomaly score for the data points in each of the sets of data, wherein a plurality of single anomaly scores is determined for the sets of data. The method may include calculating a final anomaly score for the unlabeled data based on a combination of the plurality of single anomaly scores and performing one or more actions based on the final anomaly score.

In some implementations, a device may include one or more memories and one or more processors to receive unlabeled data associated with a particular domain and select sets of data from the unlabeled data. The one or more processors may calculate Gaussian kernel densities and minimum distances for data points in each of the sets of data, and may calculate anomaly scores for the data points in each of the sets of data based on the Gaussian kernel densities and the minimum distances for the data points in each of the sets of data. The one or more processors may process the anomaly scores for the data points in each of the sets of data, with a machine learning model, to determine a single anomaly score for the data points in each of the sets of data, wherein a plurality of single anomaly scores is determined for the sets of data. The one or more processors may calculate a final anomaly score for the unlabeled data based on a combination of the plurality of single anomaly scores and may perform one or more actions based on the final anomaly score.

In some implementations, a non-transitory computer-readable medium may store a set of instructions that includes one or more instructions that, when executed by one or more processors of a device, cause the device to receive unlabeled data associated with a particular domain, and select sets of data from the unlabeled data. The one or more instructions may cause the device to calculate Gaussian kernel densities and minimum distances for data points in each of the sets of data, and calculate anomaly scores for the data points in each of the sets of data based on the Gaussian kernel densities and the minimum distances for the data points in each of the sets of data. The one or more instructions may cause the device to train a machine learning model, with the anomaly scores for the data points in each of the sets of data, to generate a trained machine learning model that determines a single anomaly score for the data points in each of the sets of data, wherein a plurality of single anomaly scores is determined for the sets of data. The one or more instructions may cause the device to identify anomalous data points in the unlabeled data based on the plurality of single anomaly scores and calculate a final anomaly score for the unlabeled data based on a combination of the plurality of single anomaly scores. The one or more instructions may cause the device to perform one or more actions based on the final anomaly score and the anomalous data points.

### BRIEF DESCRIPTION OF THE DRAWINGS

FIGS. 1A-1F are diagrams of an example implementation described herein.

FIG. 2 is a diagram illustrating an example of utilizing machine learning to detect single and cluster-type anomalies in a data set.

FIG. 3 is a diagram of an example environment in which systems and/or methods described herein may be implemented.

FIG. 4 is a diagram of example components of one or more devices of FIG. 3.

FIG. 5 is a flowchart of an example process for utilizing machine learning to detect single and cluster-type anomalies in a data set.

### DETAILED DESCRIPTION

The following detailed description of example implementations refers to the accompanying drawings. The same reference numbers in different drawings may identify the same or similar elements.

Anomaly detection techniques may be utilized to detect anomalies in data sets associated with various domains (e.g., fraud detection, manufacturing equipment, healthcare, and/or the like). Most model-based anomaly detection techniques create a profile of normal data points, and then detect data points that do not conform to the profile. However, such anomaly detection techniques are only trained to profile normal data points, do not accurately detect anomalous data points, may not be correct for all normal data points, may cause a high rate of false alarms, and/or the like. Thus, current anomaly detection techniques are ineffective and waste computing resources (e.g., processing resources, memory resources, communication resources, and/or the like), networking resources, and/or the like associated with failing to accurately detect anomalies in a data set, performing operations with anomalous data, removing the anomalies if discovered, and/or the like.

Some implementations described herein relate to an anomaly detection system that utilizes machine learning to detect single and cluster-type anomalies in a data set. For example, the anomaly detection system may receive unlabeled data associated with a particular domain, and may select sets of data from the unlabeled data. The anomaly detection system may calculate Gaussian kernel densities and minimum distances for data points in each of the sets of data and may calculate anomaly scores for the data points in each of the sets of data based on the Gaussian kernel densities and the minimum distances for the data points in each of the sets of data. The anomaly detection system may train a machine learning model, with the anomaly scores for the data points in each of the sets of data, to generate a trained machine learning model that determines a single anomaly score for the data points in each of the sets of data, wherein a plurality of single anomaly scores is determined for the sets of data. The anomaly detection system may calculate a final anomaly score for the unlabeled data based on a combination of the plurality of single anomaly scores and may perform one or more actions based on the final anomaly score.

In this way, the anomaly detection system utilizes machine learning to detect single and cluster-type anomalies in a data set. The anomaly detection system may provide a proportional anomaly detection technique that is non-parametric, robust, operates quickly, handles large size data sets, identifies single and cluster-type anomalies, and/or the like. For example, the anomaly detection system may receive unlabeled data associated with a particular domain and may select sets of data from the unlabeled data. The anomaly detection system may calculate density parameters and distance parameters for data points in each of the sets of data and may calculate anomaly scores for the data points based on the density parameters and the distance parameters. The anomaly detection system may train a random forest regression model with the anomaly scores to generate a trained random forest regression model that determines single anomaly scores for the data points. The anomaly detection system may calculate a final anomaly score for the unlabeled data based on a median of the single anomaly scores and may perform one or more actions based on the final anomaly score. This, in turn, conserves computing resources, networking resources, and/or the like that would otherwise have been wasted in failing to detect anomalies in a data set, performing operations with anomalous data, removing the anomalies if discovered, and/or the like.

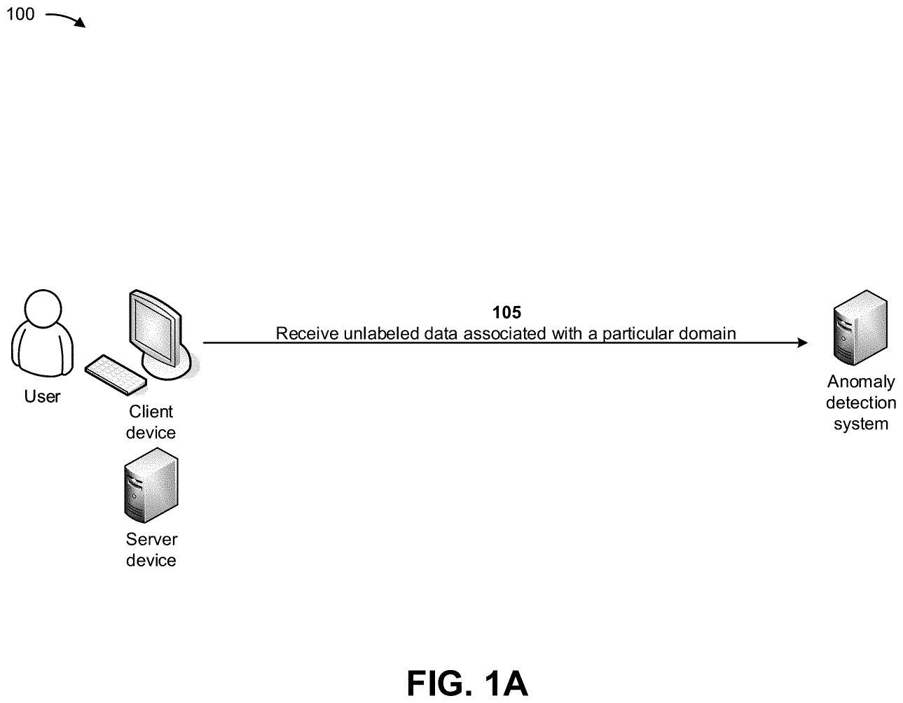

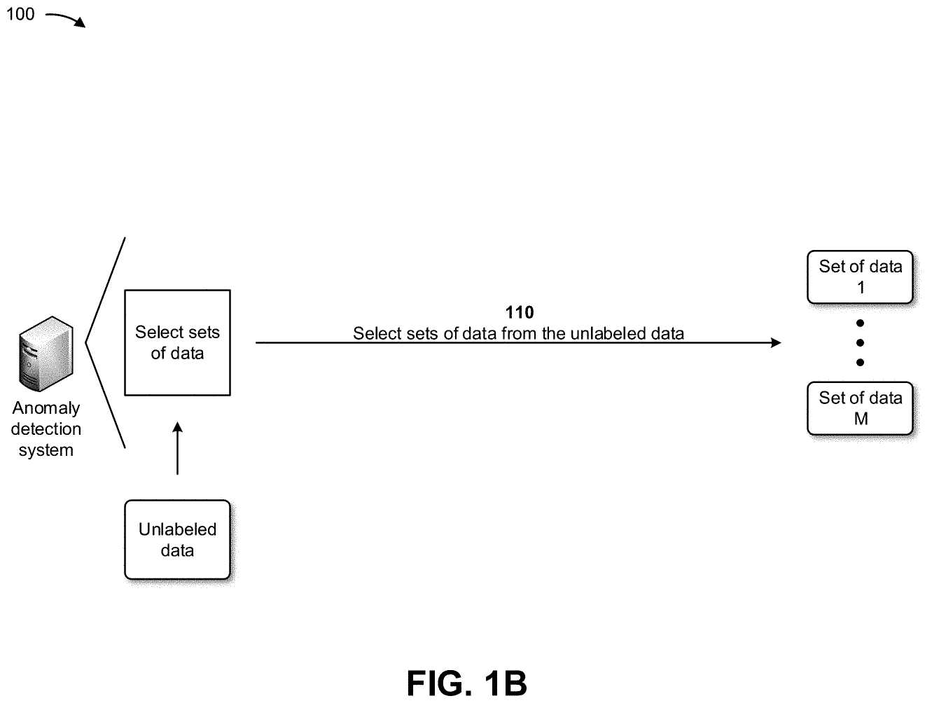

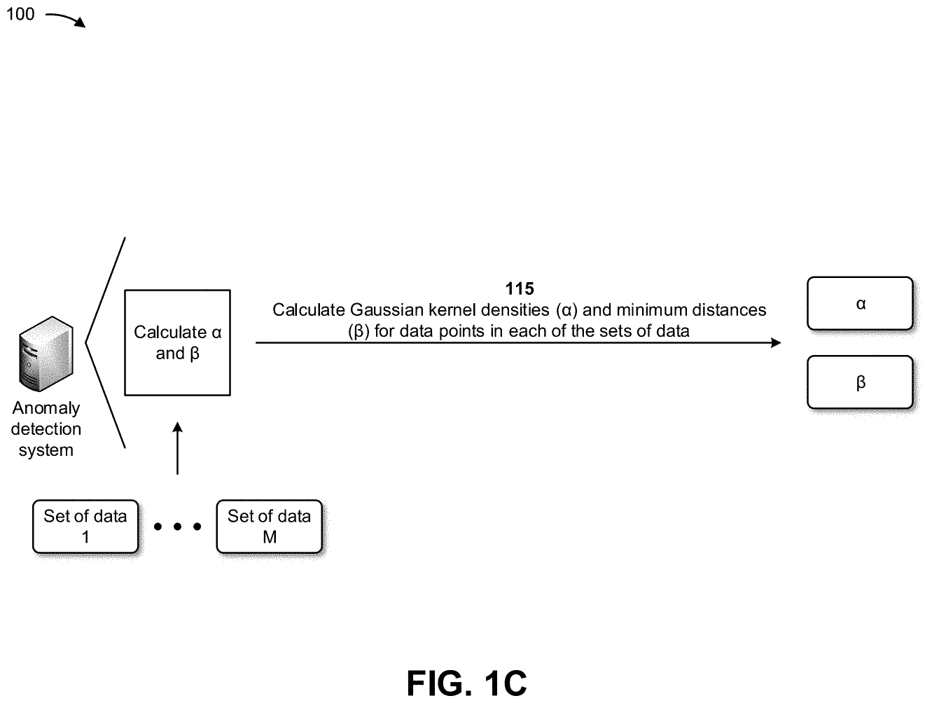

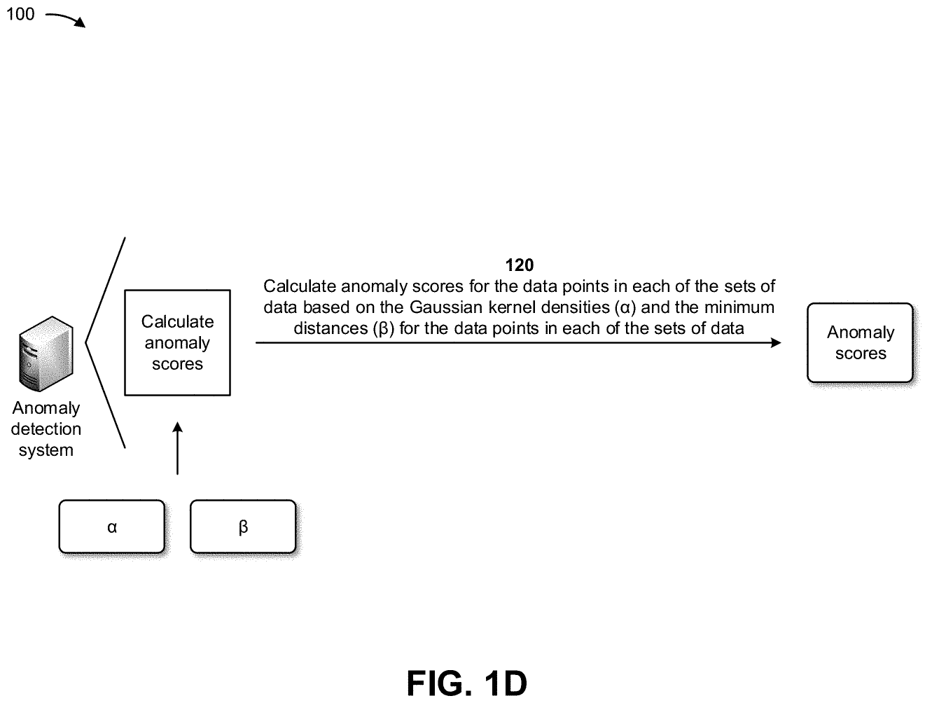

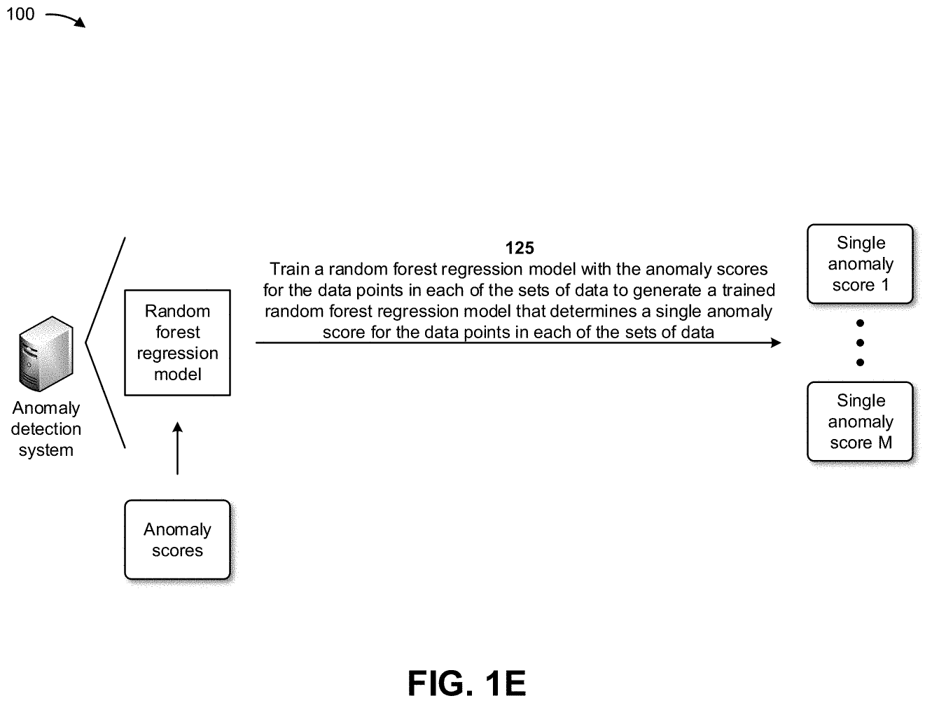

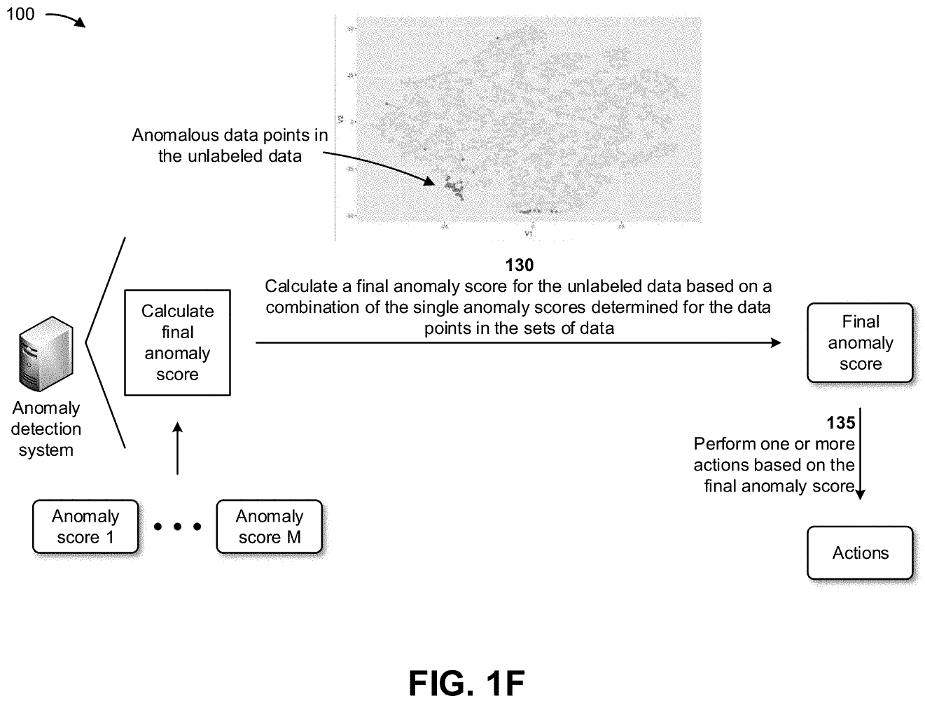

FIGS. 1A-1F are diagrams of an example 100 associated with utilizing machine learning to detect single and cluster-type anomalies in a data set. As shown in FIGS. 1A-1F, example 100 includes a client device associated with a server device and an anomaly detection system. The client device may include a mobile device, a computer, and/or the like that is associated with a user that utilizes the client device to instruct the server device to provide unlabeled data to the anomaly detection system. The server device may include one or more computing devices that store and/or utilize the unlabeled data, and that provide the unlabeled data to the anomaly detection system. The anomaly detection system may include a system that utilizes machine learning to detect single and cluster-type anomalies in a data set.

As shown in FIG. 1A, and by reference number 105, the anomaly detection system may receive, from the server device (e.g., based on an instruction from the client device), unlabeled data associated with a particular domain (e.g., fraud detection, manufacturing equipment, healthcare, and/or the like). For example, the unlabeled data may include data identifying legitimate financial transactions (e.g., associated with credit cards, debit cards, reward cards, and/or the like), fraudulent financial transactions, and/or the like when the particular domain is associated with fraud detection. In other examples, the unlabeled data may include data identifying operating parameters, inputs, outputs, alarm conditions, and/or the like of a machine (e.g., a robotic arm) when the particular domain is associated with manufacturing equipment. In still another example, the unlabeled data may include data identifying treatment efficacy, one or more drugs utilized for the treatment, efficacy of the one or more drugs, and/or the like when the particular domain is associated with healthcare.

In some implementations, there may be hundreds, thousands, and/or the like, of client devices and/or server devices that produce thousands, millions, billions, and/or the like, of data points provided in unlabeled data. In this way, the anomaly detection system may handle thousands, millions, billions, and/or the like, of data points within a period of time (e. g., daily, weekly, monthly), and thus may provide “big data” capability.

As shown in FIG. 1B, and by reference number 110, the anomaly detection system may select sets of data from the unlabeled data. For example, as shown, the anomaly detection system may select M sets of data from the unlabeled data, where M may be an integer greater than one and may be set by a user of the anomaly detection system. In some implementations, the anomaly detection system may randomly select the sets of data from the unlabeled data. Thus, each set of data may or may not include one or more data points included in other, different sets of data. The anomaly detection system may select more or less than M sets of data from the unlabeled data, may utilize a round robin selection technique to select the sets of data from the unlabeled data, may utilize a feature selection technique to select the sets of data from the unlabeled data, may utilize a classification selection technique to select the sets of data from the unlabeled data, and/or the like.

As shown in FIG. 1C, and by reference number 115, the anomaly detection system may calculate density parameters, such as Gaussian kernel densities (α), and distance parameters, such as minimum distances (β), for data points in each of the sets of data. For example, the Gaussian kernel densities may be calculated based on an equation of the form:

$${α}_{i} = \hat{f} ( x \text{;} h ) = \frac{1}{nh} {\sum }_{i = 1}^{n} K ( \frac{x - {x}_{i}}{h} ) ,$$

where xⱼ, x₂, . . . , xₙ may represent univariate independent and identically distributed data points in each of the sets of data, K may represent a non-negative kernel function, and h (e.g., >0) may represent a smoothing parameter called a bandwidth.

In some implementations, the anomaly detection system may utilize the density parameters (e.g., the Gaussian kernel densities (αᵢ)) to calculate the distance parameters (e.g., minimum distances (βᵢ)) between xᵢ and a predetermined quantity of next data points (xⱼ) with higher densities among instances as follows:

$${β}_{i} = {min}_{j : {α}_{j} > {α}_{i}} \{ ‖ {x}_{i} - {x}_{j} ‖ \} .$$

In some implementations, the minimum distances (βᵢ) between xᵢ and the predetermined quantity of next data points (xⱼ) corresponds to minimum dissimilarities between xᵢ and the predetermined quantity of next data points (xⱼ).

As shown in FIG. 1D, and by reference number 120, the anomaly detection system may calculate anomaly scores (ansᵢ) for the data points in each of the sets of data based on the density parameters (e.g., the Gaussian kernel densities (αᵢ)) and the distance parameters (e.g., the minimum distances (βᵢ)) for the data points in each of the sets of data. In some implementations, the anomaly detection system calculates the anomaly scores (ansᵢ) for the data points based on an equation of the form:

$${ans}_{i} = \frac{{β}_{i}}{{α}_{i}} .$$

Very large anomaly scores (e.g., values) may be calculated for the data points that are anomalies and small anomaly scores (e.g., values) may be calculated for the data points that are normal data points (e.g., not anomalies). The anomaly scores calculated for the data points that are anomalies may be very large relative to the anomaly scores calculated for the data points that are normal data points.

As shown in FIG. 1E, and by reference number 125, the anomaly detection system may train a machine learning model (e.g., a random forest regression model) with the anomaly scores for the data points in each of the sets of data to generate a trained random forest regression model that determines a single anomaly score for the data points in each of the sets of data. For example, the anomaly detection system may utilize the trained random forest regression model to determine a first anomaly score (e.g., single anomaly score 1) for the first set of data, a second anomaly score (e.g., single anomaly score 2) for the second set of data, . . . , and an Mth anomaly score (e.g., single anomaly score M) for the Mth set of data. In some implementations, the anomaly detection system may train the random forest regression model using the data points of each set of data and the calculated anomaly scores for the data points and may utilize the trained random forest regression model to estimate single anomaly scores for data points not included in the sets of data.

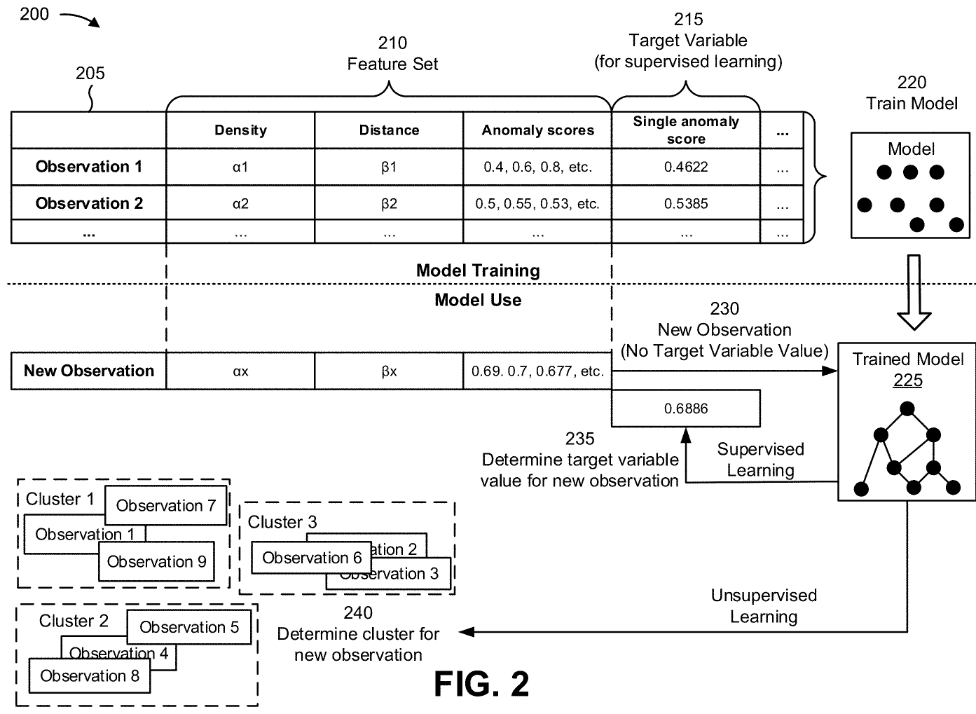

In some implementations, the anomaly detection system trains the random forest regression model with the anomaly scores for the data points in each of the sets of data in a manner similar to the manner described below in connection with FIG. 2. In some implementations, rather than training the random forest regression model, the anomaly detection system obtains the random forest regression model from another system or device that trained the random forest regression model. In this case, the anomaly detection system may provide the other system or device with data for use in training the random forest regression model and may provide the other system or device with updated data to retrain the random forest regression model in order to update the random forest regression model.

In some implementations, the trained random forest regression model determines the single anomaly score for the data points in each of the sets of data, as described above. For example, the anomaly detection system may apply the random forest regression model to new observations (e.g., data points not included in the sets of data) in a manner similar to the manner described below in connection with FIG. 2.

As shown in FIG. 1F, and by reference number 130, the anomaly detection system may calculate a final anomaly score for the unlabeled data based on a combination of the single anomaly scores calculated for the data points in the sets of data. In some implementations, the calculation of the final anomaly score is based on a median of the single anomaly scores, an average of the single anomaly scores, a weighted average of the single anomaly scores, and/or the like. As further shown, the anomaly detection system may identify anomalous data points in the unlabeled data based on the single anomaly scores calculated for the data points in the sets of data and may generate a user interface that includes identification of the anomalous data points in the unlabeled data. The anomaly detection system may provide the user interface to the client device for display or may display the user interface to a user of the anomaly detection system.

As further shown in FIG. 1F, and by reference number 135, the anomaly detection system may perform one or more actions based on the final anomaly score. In some implementations, the one or more actions include the anomaly detection system generating an alarm based on the final anomaly score. For example, if the final anomaly score satisfies a threshold score (e.g., indicating an issue with the unlabeled data), the anomaly detection system may generate and provide an alarm to the client device or to a user of the anomaly detection system. In this way, the anomaly detection system may conserve resources (e.g., computing resources, networking resources, and/or the like) that would otherwise have been wasted in failing to detect anomalies in the unlabeled data, performing operations with anomalous data, removing the anomalies if discovered, and/or the like.

In some implementations, the one or more actions include the anomaly detection system removing anomalous data points from the unlabeled data. For example, the anomaly detection system may remove, from the unlabeled data, anomalous data points associated with single anomaly scores that satisfy a threshold score (e.g., indicating anomalies). Thus, the unlabeled data will not include anomalous data points. In this way, the anomaly detection system may conserve resources that would otherwise have been wasted in failing to detect anomalies in the unlabeled data, performing operations with anomalous data, and/or the like.

In some implementations, the one or more actions include the anomaly detection system providing the final anomaly score for display to a user of the anomaly detection system or to a user of the client device. For example, the anomaly detection system may generate a user interface that includes the final anomaly score and may provide the user interface for display to the user of the anomaly detection system or to the user of the client device. In this way, the user may become aware of the degree to which the unlabeled data is anomalous, and the anomaly detection system may conserve resources that would otherwise have been wasted in failing to detect anomalies in the unlabeled data, performing operations with anomalous data, removing the anomalies if discovered, and/or the like.

In some implementations, the one or more actions include the anomaly detection system causing a fraud prevention action. For example, if the final anomaly score indicates the presence of fraud in the unlabeled data, the anomaly detection system may perform an action (e.g., disable an account, a transaction card, and/or the like) that prevents further performance of the fraud. In this way, the anomaly detection system may conserve resources that would otherwise have been wasted in failing to detect the fraud, preventing further performance of the fraud, handling customer complaints about the fraud, and/or the like.

In some implementations, the one or more actions include the anomaly detection system causing a machine to shut down. For example, if the final anomaly score indicates that the machine is malfunctioning, the anomaly detection system may cause the machine to be disabled or shut down. In this way, the anomaly detection system may conserve resources that would otherwise have been wasted in generating defective products with the machine, preventing further product damage, handling customer complaints about the damaged products, and/or the like.

In some implementations, the one or more actions include the anomaly detection system retraining a random forest regression model based on the final anomaly score. The anomaly detection system may utilize the final anomaly score as additional training data for retraining the random forest regression model, thereby increasing the quantity of training data available for training the random forest regression model. Accordingly, the anomaly detection system may conserve computing resources associated with identifying, obtaining, and/or generating historical data for training the random forest regression model relative to other systems for identifying, obtaining, and/or generating historical data for training machine learning models.

In this way, the anomaly detection system utilizes machine learning to detect single and cluster-type anomalies in a data set. The anomaly detection system may provide a proportional anomaly detection technique that is non-parametric, robust, operates quickly, handles large size data sets, identifies single and cluster-type anomalies, and/or the like. For example, the anomaly detection system may receive unlabeled data associated with a particular domain and may select sets of data from the unlabeled data. The anomaly detection system may calculate density parameters and distance parameters for data points in each of the sets of data and may calculate anomaly scores for the data points based on the density parameters and the distance parameters. The anomaly detection system may train a random forest regression model with the anomaly scores to generate a trained random forest regression model that determines single anomaly scores for the data points. The anomaly detection system may calculate a final anomaly score for the unlabeled data based on a median of the single anomaly scores and may perform one or more actions based on the final anomaly score. This, in turn, conserves computing resources, networking resources, and/or the like that would otherwise have been wasted in failing to detect anomalies in a data set, performing operations with anomalous data, removing the anomalies if discovered, and/or the like.

As indicated above, FIGS. 1A-1F are provided as an example. Other examples may differ from what is described with regard to FIGS. 1A-1F. The number and arrangement of devices shown in FIGS. 1A-1F are provided as an example. In practice, there may be additional devices, fewer devices, different devices, or differently arranged devices than those shown in FIGS. 1A-1F. Furthermore, two or more devices shown in FIGS. 1A-1F may be implemented within a single device, or a single device shown in FIGS. 1A-1F may be implemented as multiple, distributed devices. Additionally, or alternatively, a set of devices (e.g., one or more devices) shown in FIGS. 1A-1F may perform one or more functions described as being performed by another set of devices shown in FIGS. 1A-1F.

FIG. 2 is a diagram illustrating an example 200 of training and using a machine learning model (e.g., the random forest regression model) in connection with detecting single and cluster-type anomalies in a data set. The machine learning model training and usage described herein may be performed using a machine learning system. The machine learning system may include or may be included in a computing device, a server, a cloud computing environment, and/or the like, such as the anomaly detection system described in more detail elsewhere herein.

As shown by reference number 205, a machine learning model may be trained using a set of observations. The set of observations may be obtained from historical data, such as data gathered during one or more processes described herein. In some implementations, the machine learning system may receive the set of observations (e.g., as input) from the anomaly detection system, as described elsewhere herein.

As shown by reference number 210, the set of observations includes a feature set. The feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on input received from the anomaly detection system. For example, the machine learning system may identify a feature set (e.g., one or more features and/or feature values) by extracting the feature set from structured data, by performing natural language processing to extract the feature set from unstructured data, by receiving input from an operator, and/or the like.

As an example, a feature set for a set of observations may include a first feature of density, a second feature of distance, a third feature of anomaly scores, and so on. As shown, for a first observation, the first feature may have a value of α1, the second feature may have a value of β1, the third feature may have values of 0.4, 0.6, and 0.8, and so on. These features and feature values are provided as examples and may differ in other examples.

As shown by reference number 215, the set of observations may be associated with a target variable. The target variable may represent a variable having a numeric value, may represent a variable having a numeric value that falls within a range of values or has some discrete possible values, may represent a variable that is selectable from one of multiple options (e.g., one of multiple classes, classifications, labels, and/or the like), may represent a variable having a Boolean value, and/or the like. A target variable may be associated with a target variable value, and a target variable value may be specific to an observation. In example 200, the target variable is a single anomaly score, which has a value of 0.4622 for the first observation.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model.

In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

As shown by reference number 220, the machine learning system may train a machine learning model using the set of observations and using one or more machine learning algorithms, such as a regression algorithm, a decision tree algorithm, a neural network algorithm, a k-nearest neighbor algorithm, a support vector machine algorithm, and/or the like. After training, the machine learning system may store the machine learning model as a trained machine learning model 225 to be used to analyze new observations.

As shown by reference number 230, the machine learning system may apply the trained machine learning model 225 to a new observation, such as by receiving a new observation and inputting the new observation to the trained machine learning model 225. As shown, the new observation may include a first feature of ax, a second feature of βx, a third feature of 0.69, 0.7, and 0.677, and so on, as an example. The machine learning system may apply the trained machine learning model 225 to the new observation to generate an output (e.g., a result). The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs, information that indicates a degree of similarity between the new observation and one or more other observations, and/or the like, such as when unsupervised learning is employed.

As an example, the trained machine learning model 225 may predict a value of 0.6886 for the target variable of the stress level for the new observation, as shown by reference number 235. Based on this prediction, the machine learning system may provide a first recommendation, may provide output for determination of a first recommendation, may perform a first automated action, may cause a first automated action to be performed (e.g., by instructing another device to perform the automated action), and/or the like.

In some implementations, the trained machine learning model 225 may classify (e.g., cluster) the new observation in a cluster, as shown by reference number 240. The observations within a cluster may have a threshold degree of similarity. As an example, if the machine learning system classifies the new observation in a first cluster (e.g., a density cluster), then the machine learning system may provide a first recommendation. Additionally, or alternatively, the machine learning system may perform a first automated action and/or may cause a first automated action to be performed (e.g., by instructing another device to perform the automated action) based on classifying the new observation in the first cluster.

As another example, if the machine learning system were to classify the new observation in a second cluster (e.g., a distance cluster), then the machine learning system may provide a second (e.g., different) recommendation and/or may perform or cause performance of a second (e.g., different) automated action.

In some implementations, the recommendation and/or the automated action associated with the new observation may be based on a target variable value having a particular label (e.g., classification, categorization, and/or the like), may be based on whether a target variable value satisfies one or more thresholds (e.g., whether the target variable value is greater than a threshold, is less than a threshold, is equal to a threshold, falls within a range of threshold values, and/or the like), may be based on a cluster in which the new observation is classified, and/or the like.

In this way, the machine learning system may apply a rigorous and automated process to detect single and cluster-type anomalies in a data set. The machine learning system enables recognition and/or identification of tens, hundreds, thousands, or millions of features and/or feature values for tens, hundreds, thousands, or millions of observations, thereby increasing accuracy and consistency and reducing delay associated with detecting single and cluster-type anomalies in a data set relative to requiring computing resources to be allocated for tens, hundreds, or thousands of operators to manually detect single and cluster-type anomalies in a data set.

As indicated above, FIG. 2 is provided as an example. Other examples may differ from what is described in connection with FIG. 2.

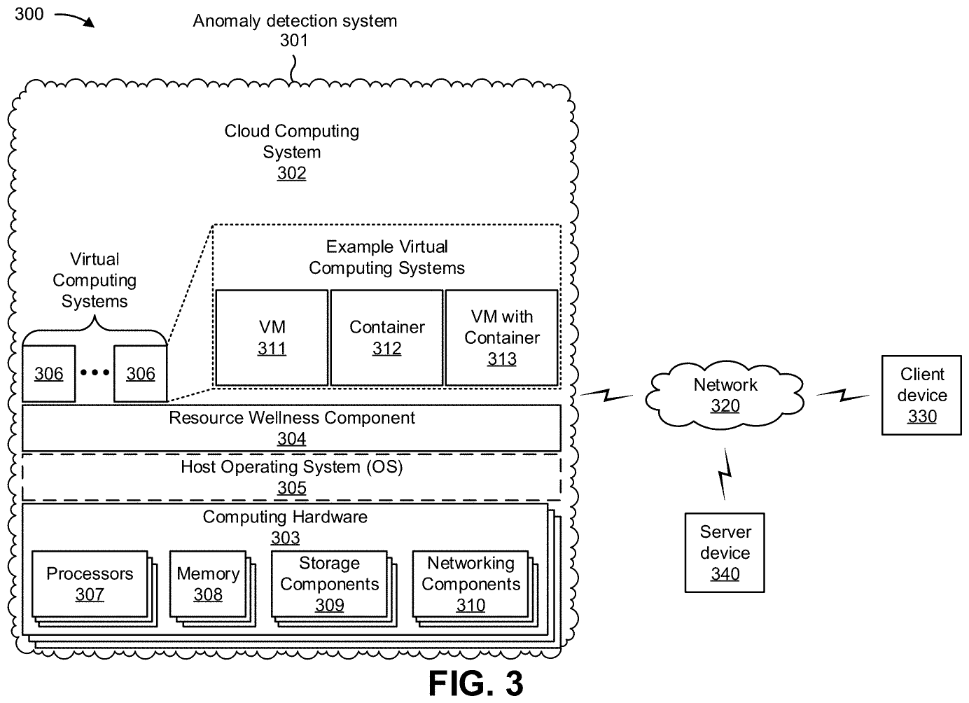

FIG. 3 is a diagram of an example environment 300 in which systems and/or methods described herein may be implemented. As shown in FIG. 3, environment 300 may include an anomaly detection system 301, which may include one or more elements of and/or may execute within a cloud computing system 302. The cloud computing system 302 may include one or more elements 303-313, as described in more detail below. As further shown in FIG. 3, environment 300 may include a network 320, a client device 330, and a server device 340. Devices and/or elements of environment 300 may interconnect via wired connections and/or wireless connections.

The cloud computing system 302 includes computing hardware 303, a resource management component 304, a host operating system (OS) 305, and/or one or more virtual computing systems 306. The resource management component 304 may perform virtualization (e.g., abstraction) of computing hardware 303 to create the one or more virtual computing systems 306. Using virtualization, the resource management component 304 enables a single computing device (e.g., a computer, a server, and/or the like) to operate like multiple computing devices, such as by creating multiple isolated virtual computing systems 306 from computing hardware 303 of the single computing device. In this way, computing hardware 303 can operate more efficiently, with lower power consumption, higher reliability, higher availability, higher utilization, greater flexibility, and lower cost than using separate computing devices.

Computing hardware 303 includes hardware and corresponding resources from one or more computing devices. For example, computing hardware 303 may include hardware from a single computing device (e.g., a single server) or from multiple computing devices (e.g., multiple servers), such as multiple computing devices in one or more data centers. As shown, computing hardware 303 may include one or more processors 307, one or more memories 308, one or more storage components 309, and/or one or more networking components 310. Examples of a processor, a memory, a storage component, and a networking component (e.g., a communication component) are described elsewhere herein.

The resource management component 304 includes a virtualization application (e.g., executing on hardware, such as computing hardware 303) capable of virtualizing computing hardware 303 to start, stop, and/or manage one or more virtual computing systems 306. For example, the resource management component 304 may include a hypervisor (e.g., a bare-metal or Type 1 hypervisor, a hosted or Type 2 hypervisor, and/or the like) or a virtual machine monitor, such as when the virtual computing systems 306 are virtual machines 311. Additionally, or alternatively, the resource management component 304 may include a container manager, such as when the virtual computing systems 306 are containers 312. In some implementations, the resource management component 304 executes within and/or in coordination with a host operating system 305.

A virtual computing system 306 includes a virtual environment that enables cloud-based execution of operations and/or processes described herein using computing hardware 303. As shown, a virtual computing system 306 may include a virtual machine 311, a container 312, a hybrid environment 313 that includes a virtual machine and a container, and/or the like. A virtual computing system 306 may execute one or more applications using a file system that includes binary files, software libraries, and/or other resources required to execute applications on a guest operating system (e.g., within the virtual computing system 306) or the host operating system 305.

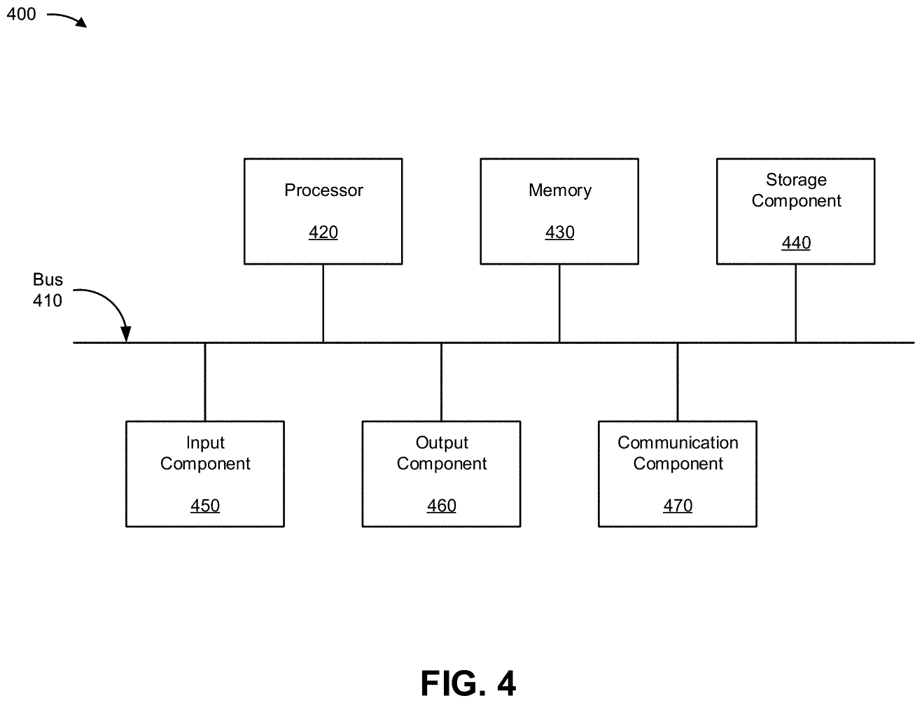

Although the anomaly detection system 301 may include one or more elements 303-313 of the cloud computing system 302, may execute within the cloud computing system 302, and/or may be hosted within the cloud computing system 302, in some implementations, the anomaly detection system 301 may not be cloud-based (e.g., may be implemented outside of a cloud computing system) or may be partially cloud-based. For example, the anomaly detection system 301 may include one or more devices that are not part of the cloud computing system 302, such as device 400 of FIG. 4, which may include a standalone server or another type of computing device. The anomaly detection system 301 may perform one or more operations and/or processes described in more detail elsewhere herein.

Network 320 includes one or more wired and/or wireless networks. For example, network 320 may include a wireless wide area network (e.g., a cellular network or a public land mobile network), a local area network (e.g., a wired local area network or a wireless local area network (WLAN), such as a Wi-Fi network), a personal area network (e.g., a Bluetooth network), a near-field communication network, a telephone network, a private network, the Internet, and/or a combination of these or other types of networks. Network 320 enables communication among the devices of environment 300.

Client device 330 includes one or more devices capable of receiving, generating, storing, processing, and/or providing information, as described elsewhere herein. Client device 330 may include a communication device and/or a computing device. For example, client device 330 may include a wireless communication device, a user equipment (UE), a mobile phone (e.g., a smart phone or a cell phone, among other examples), a laptop computer, a tablet computer, a handheld computer, a desktop computer, a gaming device, a wearable communication device (e.g., a smart wristwatch or a pair of smart eyeglasses, among other examples), an Internet of Things (IoT) device, or a similar type of device. Client device 330 may communicate with one or more other devices of environment 300, as described elsewhere herein.

Server device 340 includes one or more devices capable of receiving, generating, storing, processing, providing, and/or routing information, as described elsewhere herein. Server device 340 may include a communication device and/or a computing device. For example, server device 340 may include a server, such as an application server, a client server, a web server, a database server, a host server, a proxy server, a virtual server (e.g., executing on computing hardware), or a server in a cloud computing system. In some implementations, server device 340 includes computing hardware used in a cloud computing environment.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of environment 300 may perform one or more functions described as being performed by another set of devices of environment 300.

FIG. 4 is a diagram of example components of a device 400, which may correspond to anomaly detection system 301, client device 330, and/or server device 340. In some implementations, anomaly detection system 301, client device 330, and/or server device 340 may include one or more devices 400 and/or one or more components of device 400. As shown in FIG. 4, device 400 may include a bus 410, a processor 420, a memory 430, a storage component 440, an input component 450, an output component 460, and a communication component 470.

Bus 410 includes a component that enables wired and/or wireless communication among the components of device 400. Processor 420 includes a central processing unit, a graphics processing unit, a microprocessor, a controller, a microcontroller, a digital signal processor, a field-programmable gate array, an application-specific integrated circuit, and/or another type of processing component. Processor 420 is implemented in hardware, firmware, or a combination of hardware and software. In some implementations, processor 420 includes one or more processors capable of being programmed to perform a function. Memory 430 includes a random-access memory, a read only memory, and/or another type of memory (e.g., a flash memory, a magnetic memory, and/or an optical memory).

Storage component 440 stores information and/or software related to the operation of device 400. For example, storage component 440 may include a hard disk drive, a magnetic disk drive, an optical disk drive, a solid-state disk drive, a compact disc, a digital versatile disc, and/or another type of non-transitory computer-readable medium. Input component 450 enables device 400 to receive input, such as user input and/or sensed inputs. For example, input component 450 may include a touch screen, a keyboard, a keypad, a mouse, a button, a microphone, a switch, a sensor, a global positioning system component, an accelerometer, a gyroscope, an actuator, and/or the like. Output component 460 enables device 400 to provide output, such as via a display, a speaker, and/or one or more light-emitting diodes. Communication component 470 enables device 400 to communicate with other devices, such as via a wired connection and/or a wireless connection. For example, communication component 470 may include a receiver, a transmitter, a transceiver, a modem, a network interface card, an antenna, and/or the like.

Device 400 may perform one or more processes described herein. For example, a non-transitory computer-readable medium (e.g., memory 430 and/or storage component 440) may store a set of instructions (e.g., one or more instructions, code, software code, program code, and/or the like) for execution by processor 420. Processor 420 may execute the set of instructions to perform one or more processes described herein. In some implementations, execution of the set of instructions, by one or more processors 420, causes the one or more processors 420 and/or the device 400 to perform one or more processes described herein. In some implementations, hardwired circuitry may be used instead of or in combination with the instructions to perform one or more processes described herein. Thus, implementations described herein are not limited to any specific combination of hardware circuitry and software.

The number and arrangement of components shown in FIG. 4 are provided as an example. Device 400 may include additional components, fewer components, different components, or differently arranged components than those shown in FIG. 4. Additionally, or alternatively, a set of components (e.g., one or more components) of device 400 may perform one or more functions described as being performed by another set of components of device 400.

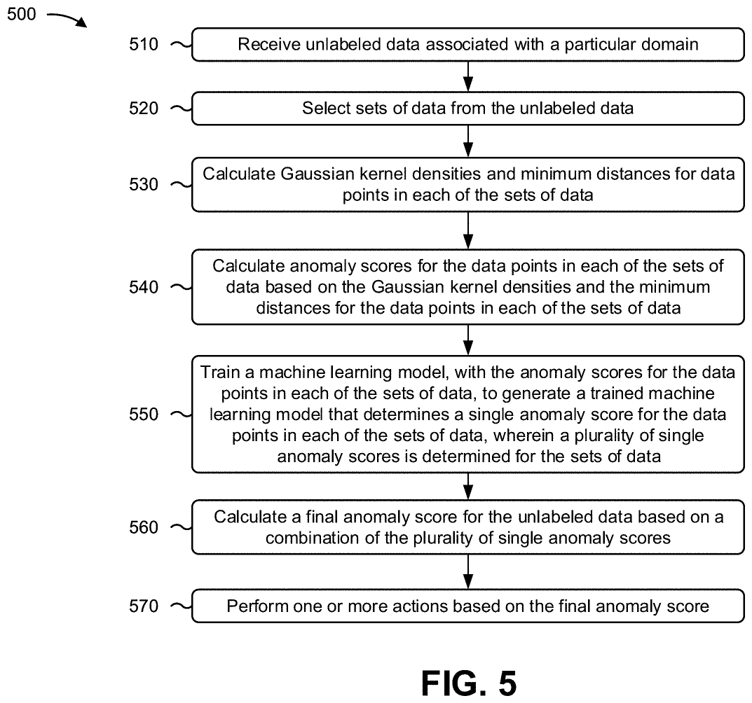

FIG. 5 is a flowchart of an example process 500 for utilizing machine learning to detect single and cluster-type anomalies in a data set. In some implementations, one or more process blocks of FIG. 5 may be performed by a device (e.g., anomaly detection system 301). In some implementations, one or more process blocks of FIG. 5 may be performed by another device or a group of devices separate from or including the device, such as a client device (e.g., client device 330) and/or a server device (e.g., server device 340). Additionally, or alternatively, one or more process blocks of FIG. 5 may be performed by one or more components of device 400, such as processor 420, memory 430, storage component 440, input component 450, output component 460, and/or communication component 470.

As shown in FIG. 5, process 500 may include receiving unlabeled data associated with a particular domain (block 510). For example, the device may receive unlabeled data associated with a particular domain, as described above.

As further shown in FIG. 5, process 500 may include selecting sets of data from the unlabeled data (block 520). For example, the device may select sets of data from the unlabeled data, as described above.

As further shown in FIG. 5, process 500 may include calculating Gaussian kernel densities and minimum distances for data points in each of the sets of data (block 530). For example, the device may calculate Gaussian kernel densities and minimum distances for data points in each of the sets of data, as described above.

As further shown in FIG. 5, process 500 may include calculating anomaly scores for the data points in each of the sets of data based on the Gaussian kernel densities and the minimum distances for the data points in each of the sets of data (block 540). For example, the device may calculate anomaly scores for the data points in each of the sets of data based on the Gaussian kernel densities and the minimum distances for the data points in each of the sets of data, as described above.

As further shown in FIG. 5, process 500 may include training a machine learning model, with the anomaly scores for the data points in each of the sets of data, to generate a trained machine learning model that determines a single anomaly score for the data points in each of the sets of data, wherein a plurality of single anomaly scores is determined for the sets of data (block 550). For example, the device may train a machine learning model, with the anomaly scores for the data points in each of the sets of data, to generate a trained machine learning model that determines a single anomaly score for the data points in each of the sets of data, as described above. In some implementations, a plurality of single anomaly scores is determined for the sets of data.

As further shown in FIG. 5, process 500 may include calculating a final anomaly score for the unlabeled data based on a combination of the plurality of single anomaly scores (block 560). For example, the device may calculate a final anomaly score for the unlabeled data based on a combination of the plurality of single anomaly scores, as described above.

As further shown in FIG. 5, process 500 may include performing one or more actions based on the final anomaly score (block 570). For example, the device may perform one or more actions based on the final anomaly score, as described above.

Process 500 may include additional implementations, such as any single implementation or any combination of implementations described below and/or in connection with one or more other processes described elsewhere herein.

In a first implementation, calculating the final anomaly score for the unlabeled data includes calculating the final anomaly score for the unlabeled data based on a median of the plurality of single anomaly scores.

In a second implementation, alone or in combination with the first implementation, the machine learning model includes a random forest regression model.

In a third implementation, alone or in combination with one or more of the first and second implementations, calculating the Gaussian kernel densities and the minimum distances for the data points in each of the sets of data includes calculating the Gaussian kernel densities for the data points based on a frequency measure associated with the data points, and calculating the minimum distances for the data points based on the Gaussian kernel densities.

In a fourth implementation, alone or in combination with one or more of the first through third implementations, each of the minimum distances for the data points represents a minimum dissimilarity between one of the data points and a predetermined quantity of next data points with greater Gaussian kernel densities.

In a fifth implementation, alone or in combination with one or more of the first through fourth implementations, calculating the anomaly scores for the data points in each of the sets of data based on the Gaussian kernel densities and the minimum distances includes dividing the minimum distances by the Gaussian kernel densities to calculate the anomaly scores for the data points.

In a sixth implementation, alone or in combination with one or more of the first through fifth implementations, training the machine learning model, with the anomaly scores for the data points in each of the sets of data, to generate the trained machine learning model includes training the machine learning model, with the anomaly scores and with the data points, to generate the trained machine learning model.

In a seventh implementation, alone or in combination with one or more of the first through sixth implementations, process 500 includes identifying anomalous data points in the unlabeled data based on the plurality of single anomaly scores, and providing data identifying the anomalous data points for display.

In an eighth implementation, alone or in combination with one or more of the first through seventh implementations, performing the one or more actions includes one or more of generating an alarm based on the final anomaly score, providing the final anomaly score for display, or causing a fraud prevention action based on the final anomaly score.

In a ninth implementation, alone or in combination with one or more of the first through eighth implementations, performing the one or more actions includes one or more of causing a machine to be disabled based on the final anomaly score, or retraining the machine learning model based on the final anomaly score.

In a tenth implementation, alone or in combination with one or more of the first through ninth implementations, performing the one or more actions includes removing anomalous data points from the unlabeled data based on the final anomaly score and to generate modified data, and providing the modified data to a client device.

In an eleventh implementation, alone or in combination with one or more of the first through tenth implementations, the particular domain includes one or more of a fraud detection domain, a manufacturing equipment domain, or a healthcare domain.

In a twelfth implementation, alone or in combination with one or more of the first through eleventh implementations, selecting the sets of data from the unlabeled data includes randomly selecting the sets of data from the unlabeled data.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

The foregoing disclosure provides illustration and description, but is not intended to be exhaustive or to limit the implementations to the precise form disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, and/or the like, depending on the context.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method, comprising:
receiving, by a device, unlabeled data associated with a particular domain;
selecting, by the device, sets of data from the unlabeled data;
calculating, by the device, Gaussian kernel densities and minimum distances for data points in each of the sets of data;
calculating, by the device, anomaly scores for the data points in each of the sets of data based on the Gaussian kernel densities and the minimum distances for the data points in each of the sets of data;
training, by the device, a machine learning model, with the anomaly scores for the data points in each of the sets of data, to generate a trained machine learning model that determines a single anomaly score for the data points in each of the sets of data,
wherein a plurality of single anomaly scores is determined for the sets of data;
calculating, by the device, a final anomaly score for the unlabeled data based on a combination of the plurality of single anomaly scores; and
performing, by the device, one or more actions based on the final anomaly score.

2. The method of claim 1, wherein calculating the final anomaly score for the unlabeled data comprises:
calculating the final anomaly score for the unlabeled data based on a median of the plurality of single anomaly scores.

3. The method of claim 1, wherein the machine learning model includes a random forest regression model.

4. The method of claim 1, wherein calculating the Gaussian kernel densities and the minimum distances for the data points in each of the sets of data comprises:
calculating the Gaussian kernel densities for the data points based on a frequency measure associated with the data points; and
calculating the minimum distances for the data points based on the Gaussian kernel densities.

5. The method of claim 1, wherein each of the minimum distances for the data points represents a minimum dissimilarity between one of the data points and a predetermined quantity of next data points with greater Gaussian kernel densities.

6. The method of claim 1, wherein calculating the anomaly scores for the data points in each of the sets of data based on the Gaussian kernel densities and the minimum distances comprises:
dividing the minimum distances by the Gaussian kernel densities to calculate the anomaly scores for the data points.

7. The method of claim 1, wherein training the machine learning model, with the anomaly scores for the data points in each of the sets of data, to generate the trained machine learning model comprises:
training the machine learning model, with the anomaly scores and with the data points, to generate the trained machine learning model.

8. A device, comprising:
one or more memories; and
one or more processors, communicatively coupled to the one or more memories, configured to:
receive unlabeled data associated with a particular domain;
select sets of data from the unlabeled data;
calculate Gaussian kernel densities and minimum distances for data points in each of the sets of data;
calculate anomaly scores for the data points in each of the sets of data based on the Gaussian kernel densities and the minimum distances for the data points in each of the sets of data;
process the anomaly scores for the data points in each of the sets of data, with a machine learning model, to determine a single anomaly score for the data points in each of the sets of data,
wherein a plurality of single anomaly scores is determined for the sets of data;
calculate a final anomaly score for the unlabeled data based on a combination of the plurality of single anomaly scores; and
perform one or more actions based on the final anomaly score.

9. The device of claim 8, wherein the one or more processors are further configured to:
identify anomalous data points in the unlabeled data based on the plurality of single anomaly scores; and
provide data identifying the anomalous data points for display.

10. The device of claim 8, wherein the one or more processors, when performing the one or more actions, are configured to one or more of:
generate an alarm based on the final anomaly score;
provide the final anomaly score for display; or
causing a fraud prevention action based on the final anomaly score.

11. The device of claim 8, wherein the one or more processors, when performing the one or more actions, are configured to one or more of:
cause a machine to be disabled based on the final anomaly score; or
retrain the machine learning model based on the final anomaly score.

12. The device of claim 8, wherein the one or more processors, when performing the one or more actions, are configured to:
remove anomalous data points from the unlabeled data based on the final anomaly score and to generate modified data; and
provide the modified data to a client device.

13. The device of claim 8, wherein the particular domain includes one or more of:
a fraud detection domain,
a manufacturing equipment domain, or
a healthcare domain.

14. The device of claim 8, wherein the one or more processors, when selecting the sets of data from the unlabeled data, are configured to:
randomly select the sets of data from the unlabeled data.

15. A non-transitory computer-readable medium storing a set of instructions, the set of instructions comprising:
one or more instructions that, when executed by one or more processors of a device, cause the device to:
receive unlabeled data associated with a particular domain;
select sets of data from the unlabeled data;
calculate Gaussian kernel densities and minimum distances for data points in each of the sets of data;
calculate anomaly scores for the data points in each of the sets of data based on the Gaussian kernel densities and the minimum distances for the data points in each of the sets of data;
train a machine learning model, with the anomaly scores for the data points in each of the sets of data, to generate a trained machine learning model that determines a single anomaly score for the data points in each of the sets of data,
wherein a plurality of single anomaly scores is determined for the sets of data;
identify anomalous data points in the unlabeled data based on the plurality of single anomaly scores;
calculate a final anomaly score for the unlabeled data based on a combination of the plurality of single anomaly scores; and
perform one or more actions based on the final anomaly score and the anomalous data points.

16. The non-transitory computer-readable medium of claim 15, wherein the one or more instructions, that cause the device to calculate the final anomaly score for the unlabeled data, cause the device to:
calculate the final anomaly score for the unlabeled data based on a median of the plurality of single anomaly scores.

17. The non-transitory computer-readable medium of claim 15, wherein the one or more instructions, that cause the device to calculate the Gaussian kernel densities and the minimum distances for the data points in each of the sets of data, cause the device to:
calculate the Gaussian kernel densities for the data points based on a frequency measure associated with the data points; and
calculate the minimum distances for the data points based on the Gaussian kernel densities.

18. The non-transitory computer-readable medium of claim 15, wherein the one or more instructions, that cause the device to calculate the anomaly scores for the data points in each of the sets of data based on the Gaussian kernel densities and the minimum distances, cause the device to:
divide the minimum distances by the Gaussian kernel densities to calculate the anomaly scores for the data points.

19. The non-transitory computer-readable medium of claim 15, wherein the one or more instructions, that cause the device to train the machine learning model, with the anomaly scores for the data points in each of the sets of data, to generate the trained machine learning model, cause the device to:
train the machine learning model, with the anomaly scores and with the data points, to generate the trained machine learning model.

20. The non-transitory computer-readable medium of claim 15, wherein the one or more instructions, that cause the device to perform the one or more actions, cause the device to one or more of:
generate an alarm based on the final anomaly score;
provide the final anomaly score for display;
generate a fraud alert based on the final anomaly score;
cause a machine to be disabled based on the final anomaly score;
retrain the machine learning model based on the final anomaly score; or
remove anomalous data points from the unlabeled data based on the final anomaly score.
